(19) United States
(12) Patent Application Publication
(10) Pub. No.: US 2026/0225383 A1
(43) Pub. Date: Aug. 6, 2026

(54) RECORDING APPARATUS

(71) Applicant: SEIKO EPSON CORPORATION, TOKYO (JP)

(72) Inventors: Seiji MIYAZAWA, MATSUMOTO-SHI (JP); Masashi KARASAWA, CHINO-SHI (JP); Shuhei MATSUMURA, SHIOJIRI-SHI (JP); Tetsuya MIYAGAWA, SHIOJIRI-SHI (JP)

(21) Appl. No.: 19/531,866

(22) Filed: Feb. 6, 2026

(30) Foreign Application Priority Data
Feb. 6, 2025 (JP) 2025-018058

(51) Int. Cl. B41J 13/03; B41J 2/165; B41J 2/17; B41J 13/076; B41J 29/02

(52) U.S. Cl. CPC B41J 13/03; B41J 2/16505; B41J 2/1721; B41J 13/076; B41J 29/02

(57) ABSTRACT

A recording apparatus includes a recording unit, a transport unit including a cylindrical hollow shaft having a first opening at one end and a second opening at the other end, a detection unit at least partially provided at a position closer to the first opening than the second opening in the hollow shaft and configured to detect a rotation amount of the hollow shaft, a contact member in contact with the hollow shaft, and a lubricant holding member configured to supply a lubricant to a contact portion between the hollow shaft and the contact member, in which the hollow shaft has a through hole formed at any position on a circumferential surface, and includes a first closing member press-fitted into the first opening to close the first opening, and the first closing member can be press-fitted into the first opening to prevent the lubricant entering an inside of the circumferential surface via the through hole from flowing out from the first opening.

The present application is based on, and claims priority from JP Application Serial Number 2025-018058, filed Feb. 6, 2025, the disclosure of which is hereby incorporated by reference herein in its entirety.

### BACKGROUND

### 1. Technical Field

The present disclosure relates to a recording apparatus.

### 2. Related Art

In the related art, a recording apparatus is used, including a recording unit, a transport unit that transports a medium by rotating in a state in which a circumferential surface is in contact with the medium, a contact member in contact with the transport unit, and a lubricant holding member that can supply a lubricant to a contact portion between the transport unit and the contact member. For example, JP-A-2016-165803 discloses a printer including a print head, a paper feed roller that transports a medium by rotating in a state in which a circumferential surface is in contact with the medium, a bearing member in contact with a rotation shaft of the paper feed roller, and a groove portion that can supply a lubricant to a contact portion between the rotation shaft of the paper feed roller and the bearing member.

JP-A-2016-165803 is an example of the related art.

Here, the transport unit may have a cylindrical hollow shaft having a first opening at one end in a rotation axis direction and a second opening at the other end in the rotation axis direction. The hollow shaft is formed into a cylindrical shape by, for example, performing pressing processing on a flat metal plate, and a through hole, such as a positioning hole or a joint, may be formed due to the pressing processing. When the through hole is formed in the hollow shaft, when a member holding the lubricant and the through hole, such as a positioning hole or a joint, are close to each other, the lubricant may enter the hollow shaft when the hollow shaft rotates, and the lubricant may travel through an inside of the hollow shaft and diffuse to an outside from the first opening or the second opening, which is an end portion of the hollow shaft. When the lubricant diffuses to the outside of the hollow shaft, the lubricant may adhere to a component, such as an encoder, near the hollow shaft.

### SUMMARY

A recording apparatus according to the present disclosure for solving the above problem includes: a recording unit configured to perform recording on a medium; a transport unit including a cylindrical hollow shaft having a first opening at one end in a rotation axis direction and a second opening at the other end in the rotation axis direction, and configured to transport the medium by rotating in a state in which a circumferential surface of the hollow shaft is in contact with the medium; a detection unit provided at least partially at a position that is closer to the first opening than is the second opening in the hollow shaft, and configured to detect a rotation amount of the hollow shaft; a contact member in contact with the hollow shaft; and a lubricant holding member configured to hold a lubricant and supply the lubricant to a contact portion between the hollow shaft and the contact member, in which the hollow shaft has a through hole formed at any position of the circumferential surface, and includes a first closing member that is a closing member press-fitted into an opening to close the opening, the first closing member being press-fitted into the first opening to close the first opening, and the first closing member can be press-fitted into the first opening to prevent a lubricant entering an inside of the circumferential surface via the through hole from flowing out from the first opening.

### BRIEF DESCRIPTION OF THE DRAWINGS

FIG. 1 is a perspective view of a recording apparatus according to Embodiment 1 of the present disclosure.

FIG. 2 is an enlarged view of a region in FIG. 1.

FIG. 3 is a perspective view of the periphery of a detection unit of the recording apparatus of FIG. 1.

FIG. 4 is a perspective view of the periphery of the detection unit of the recording apparatus of FIG. 1 viewed from an angle different from that in FIG. 3.

FIG. 5 is a perspective cross-sectional view of the periphery of a hollow shaft of a transport unit of the recording apparatus of FIG. 1.

FIG. 6 is a perspective cross-sectional view of the periphery of the detection unit of the recording apparatus of FIG. 1.

FIG. 7 is a perspective view of the periphery of a platen and a cleaning unit of the recording apparatus of FIG. 1.

FIG. 8 is a perspective view of the hollow shaft of the transport unit of the recording apparatus of FIG. 1.

FIG. 9 is a perspective view of the hollow shaft of the transport unit of the recording apparatus of FIG. 1 viewed from an angle different from that in FIG. 8.

FIG. 10 is a perspective view of the periphery of a detection unit of a recording apparatus according to Embodiment 2 of the present disclosure.

FIG. 11 is a perspective cross-sectional view of the periphery of the detection unit of the recording apparatus of FIG. 10.

FIG. 12 is a perspective view of a closing member of the recording apparatus of FIG. 10.

FIG. 13 is a schematic diagram illustrating a closing member of a recording apparatus according to Embodiment 3 of the present disclosure.

FIG. 14 is a perspective cross-sectional view of the periphery of a detection unit of a recording apparatus according to Embodiment 4 of the present disclosure.

### DESCRIPTION OF EMBODIMENTS

First, an overview of the present disclosure will be described.

A recording apparatus according to a first aspect of the present disclosure for solving the above problem includes: a recording unit configured to perform recording on a medium; a transport unit including a cylindrical hollow shaft having a first opening at one end in a rotation axis direction and a second opening at the other end in the rotation axis direction, and configured to transport the medium by rotating in a state in which a circumferential surface of the hollow shaft is in contact with the medium; a detection unit provided at least partially at a position that is closer to the first opening than is the second opening in the hollow shaft, and configured to detect a rotation amount of the hollow shaft; a contact member in contact with the hollow shaft; and a lubricant holding member configured to hold a lubricant and supply the lubricant to a contact portion between the hollow shaft and the contact member, in which the hollow shaft has a through hole formed at any position of the circumferential surface, and includes a first closing member that is a closing member press-fitted into an opening to close the opening, the first closing member being press-fitted into the first opening to close the first opening, and the first closing member can be press-fitted into the first opening to prevent a lubricant entering an inside of the circumferential surface via the through hole from flowing out from the first opening.

According to this aspect, the recording apparatus includes the first closing member press-fitted into the first opening to close the first opening, and the first closing member can be press-fitted into the first opening to prevent the lubricant entering the inside of the circumferential surface via the through hole from flowing out from the first opening. Therefore, the closing member is provided in the first opening on a side where the detection unit is provided. It is possible to prevent the lubricant from adhering to the detection unit, and it is possible to prevent the lubricant from diffusing as the hollow shaft constituting the transport unit rotates.

The recording apparatus according to a second aspect of the present disclosure is an aspect involved in the first aspect, in which the hollow shaft includes a second closing member that is the closing member and is press-fitted into the second opening to close the second opening.

According to this aspect, the hollow shaft includes the second closing member press-fitted into the second opening to close the second opening. With such a configuration, even when the lubricant reaches the second opening, the second closing member can prevent the lubricant from diffusing to the outside of the hollow shaft.

The recording apparatus according to a third aspect of the present disclosure is an aspect involved in the first or second aspect, in which the closing member has absorbency and is configured to absorb a lubricant.

According to this aspect, the closing member has absorbency and is configured to absorb a lubricant. With such a configuration, the lubricant entering the inside of the hollow shaft can be captured by the closing member, and the lubricant can be more effectively prevented from diffusing.

The recording apparatus according to a fourth aspect of the present disclosure is an aspect involved in the first or second aspect, in which the recording unit performs recording by ejecting a liquid onto the medium, the recording apparatus further includes a first waste liquid absorber configured to absorb a liquid discharged from the recording unit in a cleaning operation of the recording unit, the closing member has absorbency and is configured to absorb a lubricant, and a material of the closing member is the same as a material of the first waste liquid absorber.

According to this aspect, the first waste liquid absorber that absorbs the liquid discharged from the recording unit in the cleaning operation of the recording unit is provided. Therefore, the liquid discharged from the recording unit in the cleaning operation of the recording unit can be prevented from scattering. The first waste liquid absorber can also capture liquid mist floating in the recording apparatus. That is, it is possible to prevent not only the lubricant but also the liquid from adhering to the detection unit. The material of the closing member is the same as the material of the first waste liquid absorber. Therefore, the cost of the closing member and the first waste liquid absorber can be reduced.

The recording apparatus according to a fifth aspect according to the present disclosure is an aspect involved in the first or second aspect, in which the recording unit performs recording by ejecting a liquid onto the medium, the recording apparatus further includes a second waste liquid absorber configured to absorb a liquid which is ejected from the recording unit and spills over from the medium in a recording operation, the closing member has absorbency and is configured to absorb a lubricant, and a material of the closing member is the same as a material of the second waste liquid absorber.

According to this aspect, the second waste liquid absorber that absorbs a liquid which is ejected from the recording unit and spills over from the medium in the recording operation is provided. Therefore, it is possible to prevent liquid mist floating in the recording apparatus from being generated and to capture the liquid mist by the second waste liquid absorber. That is, it is possible to prevent not only the lubricant but also the liquid from adhering to the detection unit. The material of the closing member is the same as the material of the second waste liquid absorber. Therefore, the cost of the closing member and the second waste liquid absorber can be reduced.

The recording apparatus according to a sixth aspect of the present disclosure is an aspect involved in the first or second aspect, in which the recording unit performs recording by ejecting a liquid onto the medium, the recording apparatus includes a cap configured to cover a liquid ejection surface of the liquid of the recording unit, and a third waste liquid absorber provided in the cap and configured to absorb a liquid ejected from the recording unit, the closing member has absorbency and is configured to absorb a lubricant, and a material of the closing member is the same as a material of the third waste liquid absorber.

According to this aspect, the third waste liquid absorber which is provided in the cap and absorbs the liquid ejected from the recording unit is provided. Therefore, it is possible to prevent liquid mist floating in the recording apparatus from being generated and to capture the liquid mist by the third waste liquid absorber. That is, it is possible to prevent not only the lubricant but also the liquid from adhering to the detection unit of the liquid. The material of the closing member is the same as the material of the third waste liquid absorber. Therefore, the cost of the closing member and the third waste liquid absorber can be reduced.

The recording apparatus according to a seventh aspect of the present disclosure is an aspect involved in any one of first to sixth aspects, in which the first closing member includes an insertion portion inserted into the hollow shaft, and an abutment portion configured to prevent the first closing member from moving in a direction from the first opening toward the second opening by at least partially abutting against an edge of the first opening when the insertion portion is inserted into the hollow shaft.

According to this aspect, the first closing member includes the insertion portion inserted into the hollow shaft, and the abutment portion configured to prevent the first closing member from moving in the direction from the first opening toward the second opening by at least partially abutting against the edge of the first opening when the insertion portion is inserted into the hollow shaft. That is, since at least a part of the first closing member does not enter the inside of the hollow shaft, the entire first closing member can be prevented from entering the inside of the hollow shaft and moving to an unexpected position.

The recording apparatus according to an eighth aspect of the present disclosure is an aspect involved in any one of the first to seventh aspects, and includes a frame made of metal, in which the hollow shaft and the contact member are made of metal, and the contact member is in contact with the frame.

According to this aspect, a frame made of metal is provided, the hollow shaft and the contact member are made of metal, and the contact member is in contact with the frame. With such a configuration, the hollow shaft made of metal and the frame made of metal can be connected by the contact member made of metal, and the transport unit can be earthed.

The recording apparatus according to a ninth aspect of the present disclosure is an aspect involved in any one of the first to eighth aspects, in which the first closing member is formed of a porous member, and in a state in which the first closing member is inserted into the hollow shaft, a bubble density of the porous member decreases toward the first opening and increases away from the first opening.

According to this aspect, the first closing member is formed of a porous member, and in the state in which the first closing member is inserted into the hollow shaft, the bubble density of the porous member decreases toward the first opening and increases away from the first opening. The capillary phenomenon occurs such that the higher the bubble density is, the faster the substance moves, and the lower the bubble density is, the slower the substance moves. Therefore, with such a configuration, a suction force caused by the capillary phenomenon can be reduced as approaching the first opening, the lubricant is less likely to move to a first opening side, and the possibility that the lubricant leaks from the first opening can be reduced.

The recording apparatus according to a tenth aspect of the present disclosure is an aspect involved in the ninth aspect, in which in a state before the first closing member is inserted into the hollow shaft, the porous member has a cross-sectional area increasing from a first direction side toward a second direction side, and is inserted into the hollow shaft from the opening with the second direction side as a head.

According to this aspect, in the state before the first closing member is inserted into the hollow shaft, the porous member has a cross-sectional area increasing from the first direction toward the second direction side, and is inserted into the hollow shaft from the opening with the second direction side as a head. With such a configuration, it is possible to increase the bubble density on a through hole side (a side opposite to the first opening) when inserted into the hollow shaft. By reducing a suction force caused by the capillary phenomenon from the through hole side to the first opening side, the lubricant is less likely to move to the first opening side, and the possibility that the lubricant leaks from the first opening can be reduced.

The recording apparatus according to an eleventh aspect of the present disclosure is an aspect involved in the ninth or tenth aspect, in which the first closing member includes a through-hole-side closing member inserted into a first region including at least a part of a region between the through hole and the first opening, and a first-opening-side closing member inserted into a second region that is closer to the first opening than is the first region, and a bubble density of the first-opening-side closing member is less than a bubble density of the through-hole-side closing member.

According to this aspect, the bubble density of the first-opening-side closing member is less than the bubble density of the through-hole-side closing member. With such a configuration, the suction force caused by the capillary phenomenon can be reduced from the through hole side to the first opening side. Therefore, the lubricant is less likely to move to the first opening side, and the possibility that the lubricant leaks from the first opening can be reduced.

### Embodiment 1

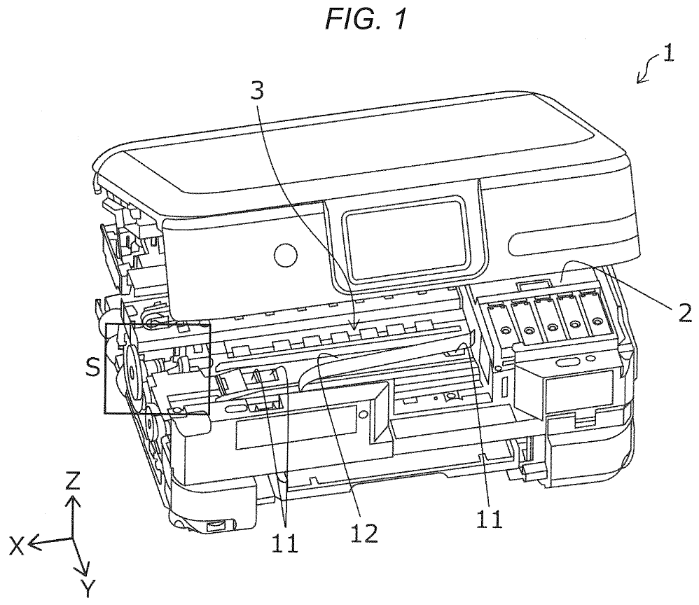

The present disclosure will be specifically described below. First, an outline of a recording apparatus 1 according to Embodiment 1 of the present disclosure will be described with reference to FIG. 1. In an X-Y-Z coordinate system illustrated in the drawings, an X-axis direction is a lateral direction, that is, a width direction of the apparatus, a Y-axis direction is a frontward direction (a front direction) and a backward direction of the apparatus, and a Z-axis direction is a height direction and the direction of gravity of the apparatus. In the drawings, a part of components may be omitted or simplified to facilitate understanding of an internal configuration.

As illustrated in FIG. 1, the recording apparatus 1 according to the embodiment includes a platen 11, a recording unit 2 that performs recording on a medium supported by the platen 11, and a transport unit 3 that transports the medium. The recording unit 2 is an inkjet recording head in a serial recording type, and may be a line head in a line recording type having a length corresponding to a maximum width of the medium. In the serial recording type, recording is performed on a medium by alternately performing a transport operation in which the transport unit 3 transports the medium to a next recording position and a recording operation in which the recording unit 2 performs recording corresponding to one line (one pass) on the medium while moving in the X-axis direction (a scanning direction).

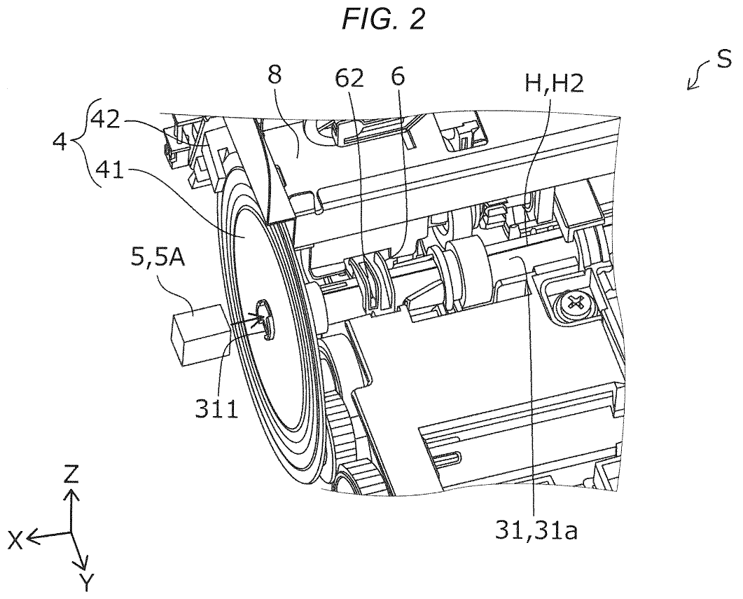

Next, details of the transport unit 3 and components around the transport unit 3 will be described with reference to FIGS. 2 to 8. As illustrated in FIG. 2, the transport unit 3 includes a hollow shaft 31 as a transport roller, and transports the medium by rotating in a state in which a circumferential surface 31a of the hollow shaft 31 is in contact with the medium. As illustrated in FIG. 2, the recording apparatus 1 of the embodiment includes a detection unit 4 that detects a rotation amount of the hollow shaft 31 of the transport unit 3, and a contact member 6 in contact with the hollow shaft 31 of the transport unit 3.

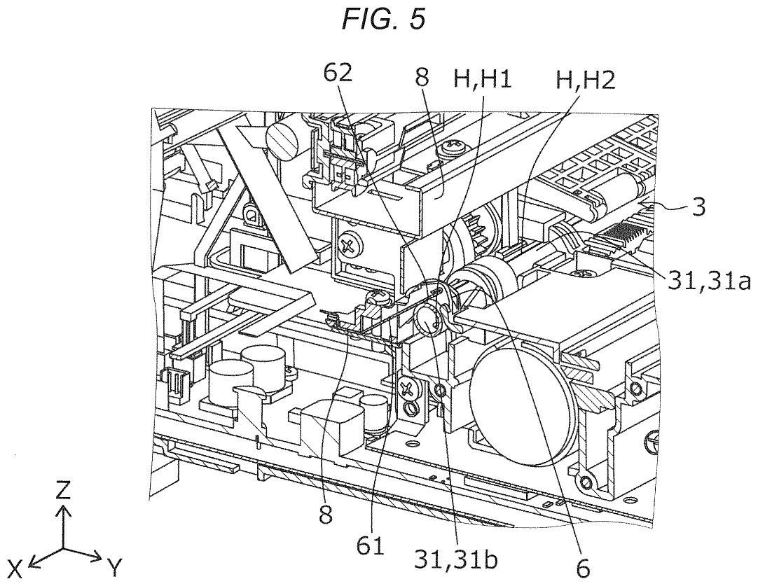

As illustrated in FIG. 5 and the like, the recording apparatus 1 according to the embodiment includes a metal frame 8. As illustrated in FIG. 5, the contact member 6 includes a spring member 61. Here, the hollow shaft 31 and the spring member 61 are both made of metal, and the contact member 6 is in contact with the frame 8 at least at the spring member 61. Therefore, the spring member 61 can be regarded as a contact member in contact with the hollow shaft 31. With such a configuration, the recording apparatus 1 according to the embodiment has a configuration in which the metal hollow shaft 31 and the metal frame 8 can be connected by the metal spring member 61, and the transport unit 3 can be earthed.

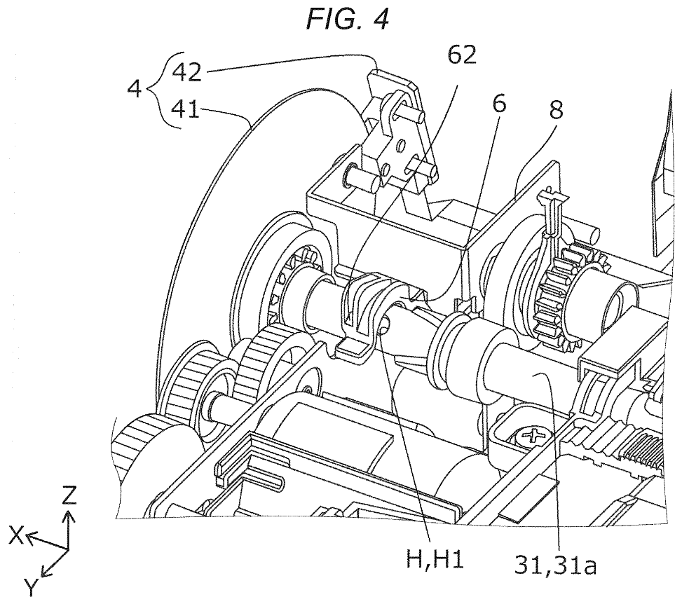

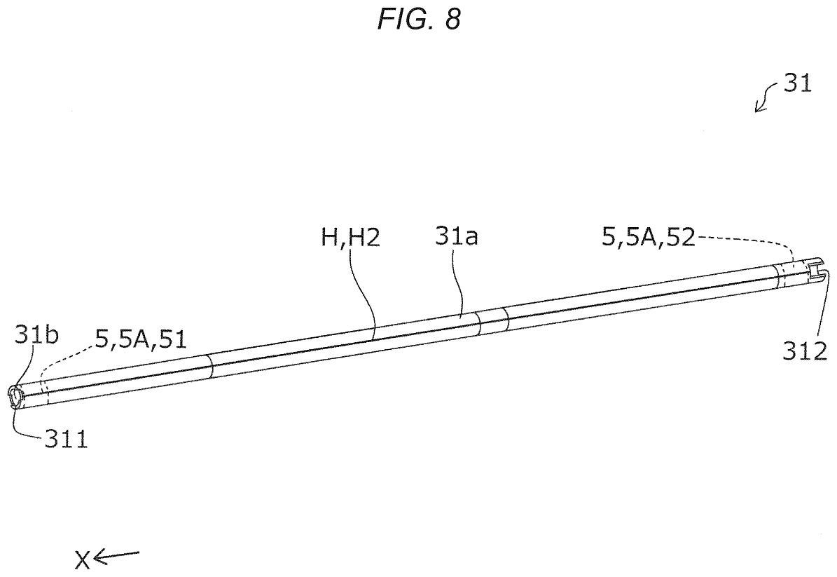

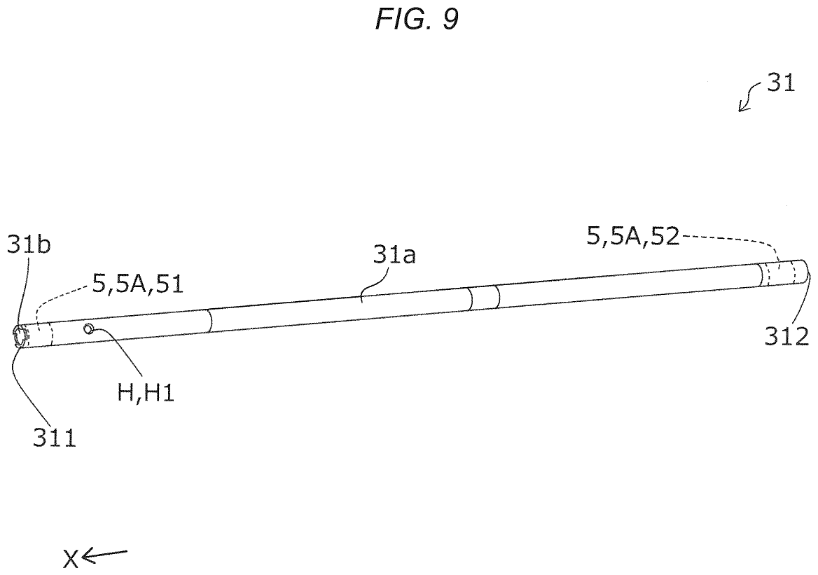

As illustrated in FIGS. 2 and 4, to reduce a friction force caused by contact between the hollow shaft 31 and the contact member 6, the recording apparatus 1 according to the embodiment includes a lubricant holding member 62 that can hold a lubricant and supply the lubricant to a contact portion between the hollow shaft 31 and the contact member 6, specifically, a contact portion between the hollow shaft 31 and the spring member 61. Specifically, the lubricant holding member 62 is a groove-shaped recess formed in the contact member 6. As illustrated in FIGS. 8, 9 and the like, the hollow shaft 31 has a cylindrical shape having a first opening 311 at one end in a rotation axis direction and a second opening 312 at the other end in the rotation axis direction.

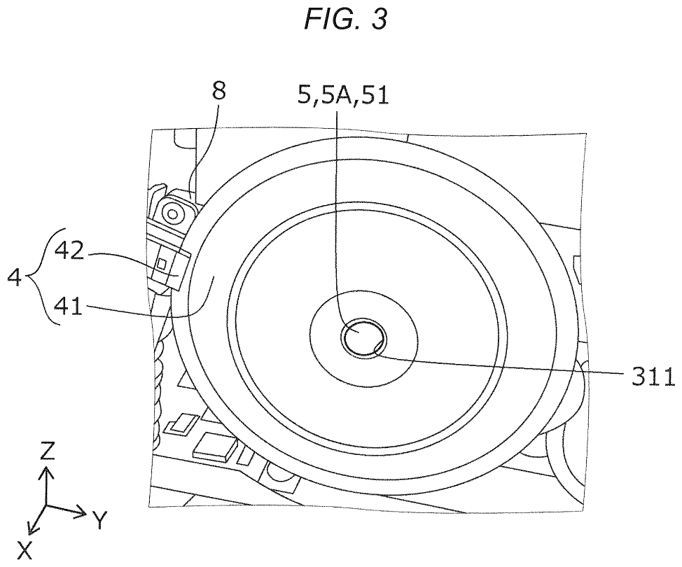

As illustrated in FIGS. 2, 3 and the like, at least a part of the detection unit 4 is provided at a position closer to the first opening 311 than to the second opening 312 in the hollow shaft 31. The detection unit 4 includes an encoder scale 41 fixed to the hollow shaft 31 and rotating together with the hollow shaft 31, and an optical sensor 42 fixed to the frame 8.

Here, as illustrated in FIGS. 4 to 6 and FIGS. 8 and 9, the hollow shaft 31 constituting the transport unit 3 is provided with through holes H, such as a round hole H1 and a joint H2, in the circumferential surface 31a. In the embodiment, the hollow shaft 31 is formed by rolling a flat plate-shaped metal member into a cylindrical shape while positioning the member. Specifically, positioning is performed by the round hole H1, and the joint H2 is a portion where sides of the flat plate-shaped member meet. Therefore, the through holes H are generated when the hollow shaft 31 is formed.

In the hollow shaft 31 in which the through holes H are provided in the circumferential surface 31a, the lubricant supplied from the lubricant holding member 62 to the contact portion between the hollow shaft 31 and the contact member 6 may enter an inside 31b of the hollow shaft 31 from the through holes H. The lubricant that enters the inside 31b of the hollow shaft 31 may move in the inside 31b and diffuse to the outside from the openings of the hollow shaft 31 as the hollow shaft 31 rotates. When the encoder scale 41 is provided at an end of the hollow shaft 31, the lubricant flowing to the outside may adhere to the encoder scale 41, and the rotation amount of the hollow shaft 31 may not be detected.

Therefore, as illustrated in FIGS. 3, 6, 8, and 9, the hollow shaft 31 includes a first closing member 51 that is a closing member 5 (a closing member 5A) press-fitted into the opening to close the opening, and the first closing member 51 is press-fitted into the first opening 311 to close the first opening 311. The first closing member 51 is press-fitted into the first opening 311, such that the lubricant that enters an inside of the circumferential surface 31a from the through holes H can be prevented from flowing out from the first opening 311. Therefore, in the recording apparatus 1 according to the embodiment, the closing member 5 is provided in the first opening 311 on a side where the detection unit 4 is provided. It is possible to prevent the lubricant from adhering to the detection unit 4, and it is possible to prevent the lubricant from diffusing as the hollow shaft 31 constituting the transport unit 3 rotates. A first closing member may not be press-fitted into the first opening 311 and may be provided at a position where the lubricant propagating from the lubricant holding member 62 to the encoder scale 41 can be prevented from moving. For example, the first closing member may be provided to cover the first opening 311 from the outside. The first closing member may be provided on the circumferential surface 31a of the hollow shaft 31 between the encoder scale 41 and the first opening 311.

Further, as illustrated in FIGS. 8 and 9, the hollow shaft 31 also includes a second closing member 52 that is the closing member 5 and is press-fitted into the second opening 312 to close the second opening 312. With such a configuration, in the recording apparatus 1 according to the embodiment, even when the lubricant reaches the second opening 312, the second closing member 52 can prevent the lubricant from diffusing to the outside of the hollow shaft 31.

Here, both the first closing member 51 and the second closing member 52 of the closing member 5A provided in the recording apparatus 1 according to the embodiment have absorbency and are absorbents capable of absorbing a lubricant. With such a configuration, the lubricant entering the inside of the hollow shaft 31 can be captured by the closing member 5A, and the lubricant can be more effectively prevented from diffusing.

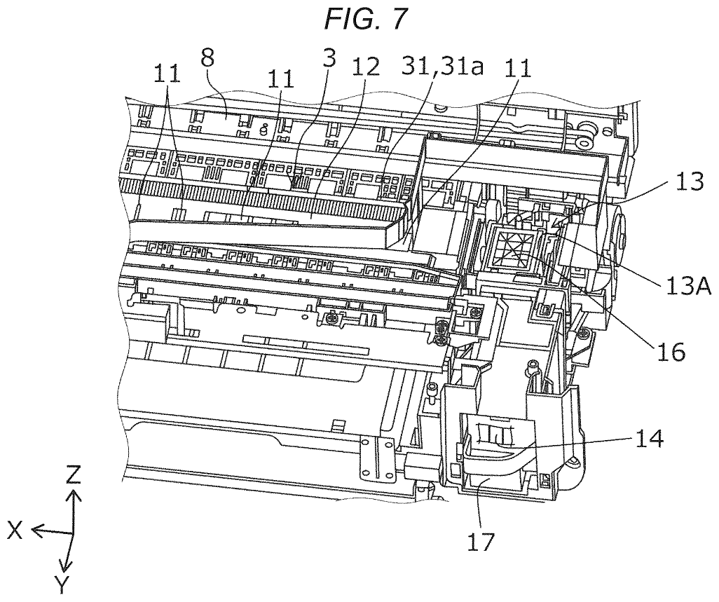

As illustrated in FIG. 7, the recording apparatus 1 according to the embodiment includes a cleaning unit 13 capable of executing a cleaning operation of the recording unit 2. The cleaning unit 13 includes a flushing unit 13A capable of ejecting an ink, which is a liquid, from the recording unit 2. The flushing unit 13A is provided with a waste ink tank 17 into which the ink flushed into the flushing unit 13A flows. In FIG. 7, a part of the waste ink tank 17 is illustrated transparently. As illustrated in FIG. 7, a first waste liquid absorber 14 is provided inside the waste ink tank 17. From another viewpoint, the recording unit 2 performs recording by ejecting the ink onto the medium. The recording apparatus 1 according to the embodiment includes the first waste liquid absorber 14 that absorbs the ink discharged from the recording unit 2 in the cleaning operation of the recording unit 2.

As described above, the closing member 5A has absorbency and can absorb the lubricant. A material of the closing member 5A is the same as a material of the first waste liquid absorber 14. In this way, by providing the first waste liquid absorber 14 that absorbs the ink discharged from the recording unit 2 in the cleaning operation of the recording unit 2, it is possible to prevent the ink discharged from the recording unit 2 from scattering in the cleaning operation of the recording unit 2. The first waste liquid absorber 14 can also capture ink mist floating inside the recording apparatus 1 according to the embodiment. That is, it is possible to prevent not only the lubricant but also the ink from adhering to the detection unit 4. Since the material of the closing member 5A is the same as the material of the first waste liquid absorber 14, the cost of the closing member 5A and the first waste liquid absorber 14 can be reduced.

As illustrated in FIGS. 1 and 7, the recording apparatus 1 according to the embodiment is provided with a second waste liquid absorber 12 that is an absorber capable of absorbing the ink around the platen 11. From another viewpoint, the recording unit 2 performs recording by ejecting the ink onto the medium, and the recording apparatus 1 according to the embodiment includes the second waste liquid absorber 12 that absorbs the ink which is ejected from the recording unit 2 and spills over from the medium in the recording operation. As described above, the closing member 5A has absorbency and can absorb the lubricant. The material of the closing member 5A is the same as a material of the second waste liquid absorber 12.

Since the recording apparatus 1 according to the embodiment has such a configuration, it is possible to prevent the ink mist floating in the recording apparatus 1 from being generated and to capture the ink mist by the second waste liquid absorber 12. That is, it is possible to prevent not only the lubricant but also the ink from adhering to the detection unit 4. Since the material of the closing member 5A is the same as the material of the second waste liquid absorber 12, the cost of the closing member 5A and the second waste liquid absorber 12 can be reduced.

As described above, the recording apparatus 1 according to the embodiment includes the flushing unit 13A. The flushing unit 13A also serves as a cap capable of covering an ink ejection surface of the recording unit 2, and as illustrated in FIG. 7, includes a third waste liquid absorber 16 that is provided in the flushing unit 13A serving as a cap and absorbs the ink ejected from the recording unit 2 in the cap. The material of the closing member 5A is the same as a material of the third waste liquid absorber 16.

Since the recording apparatus 1 according to the embodiment has such a configuration, it is possible to prevent the ink mist floating in the recording apparatus 1 from being generated and to capture the ink mist by the third waste liquid absorber 16. That is, it is possible to prevent not only the lubricant but also the ink from adhering to the detection unit 4. The material of the closing member 5A is the same as the material of the third waste liquid absorber 16. Therefore, the cost of the closing member 5A and the third waste liquid absorber 16 can be reduced.

Specifically, both the first closing member 51 and the second closing member 52 of the closing member 5A are made of a porous member. Here, the porous member includes a sponge, a foam material, a nonwoven fabric, and the like. Both the first closing member 51 and the second closing member 52 of the closing member 5A according to the embodiment are nonwoven fabrics. In the embodiment, as illustrated in FIG. 2, the first closing member 51 and the second closing member 52, which are the nonwoven fabrics formed in a rectangular parallelepiped shape, are inserted from the first opening 311 and the second opening 312, respectively. In a state in which the closing member 5 is inserted into the hollow shaft 31, a bubble density of the porous member of the first closing member 51 decreases toward the first opening 311 and increases away from the first opening 311. When the porous member is a nonwoven fabric, the bubble density of the porous member corresponds to a density of each cell in the nonwoven fabric.

Here, a capillary phenomenon occurs such that the higher the bubble density is, the faster the substance moves, and the lower the bubble density is, the slower the substance moves. Therefore, with such a configuration, a suction force caused by the capillary phenomenon can be reduced as approaching the first opening 311, the lubricant is less likely to move to the first opening 311 side, and the possibility that the lubricant leaks from the first opening 311 can be reduced. Similarly to the first closing member 51, the second closing member 52 is also configured such that the bubble density of the porous member decreases toward the second opening 312 and increases away from the second opening 312.

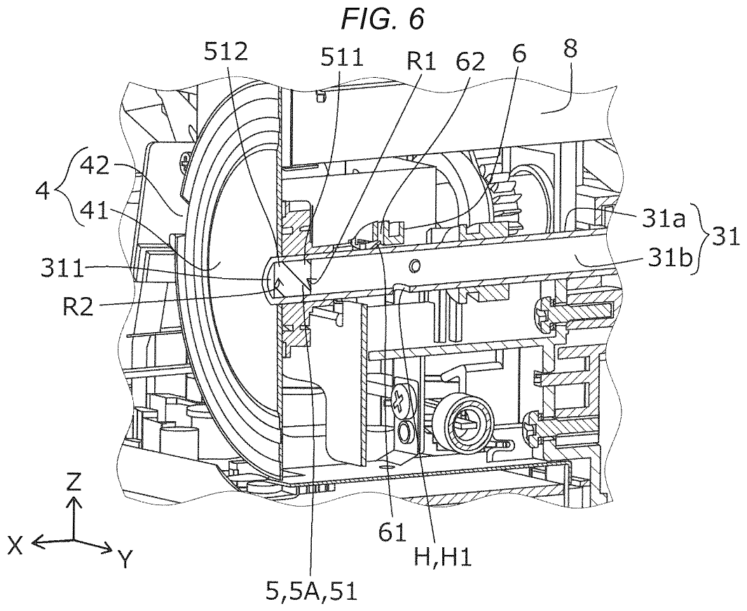

In other words, as illustrated in FIG. 6, the first closing member 51 as the closing member 5 is formed by one member, and includes a through-hole-side closing member 511 inserted into a first region R1 including at least a part of a region between the through hole H and the first opening 311, and a first-opening-side closing member 512 inserted into a second region R2, which is a region closer to the first opening 311 than the first region R1. A bubble density of the first-opening-side closing member 512 is less than a bubble density of the through-hole-side closing member 511. With such a configuration, the suction force caused by the capillary phenomenon can be reduced from a through hole H side to the first opening 311 side. Therefore, the lubricant is less likely to move to the first opening 311 side, and the possibility that the lubricant leaks from the first opening 311 can be reduced. The second closing member 52 also has the same configuration as the first closing member 51.

### Embodiment 2

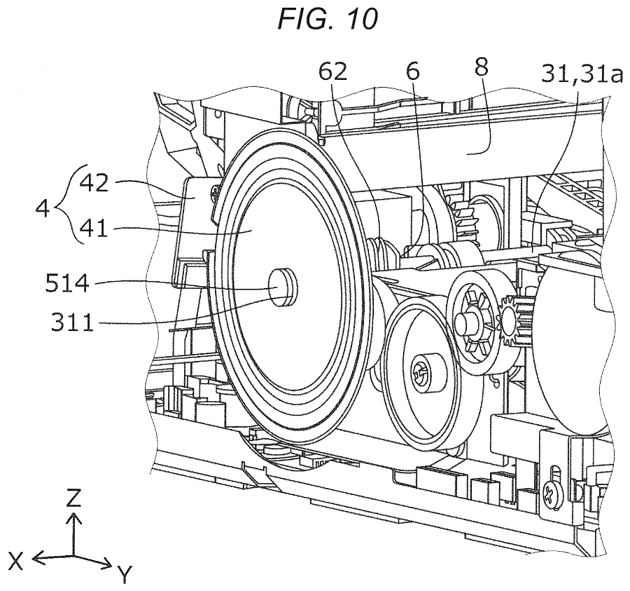

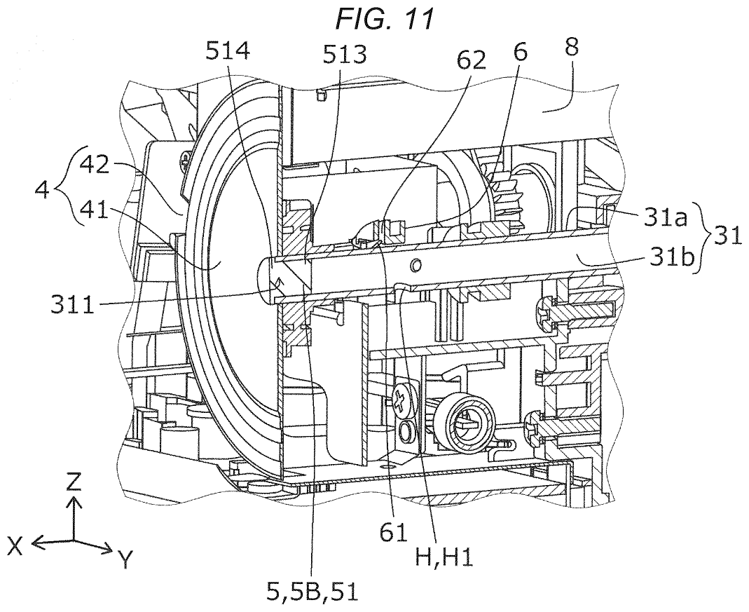

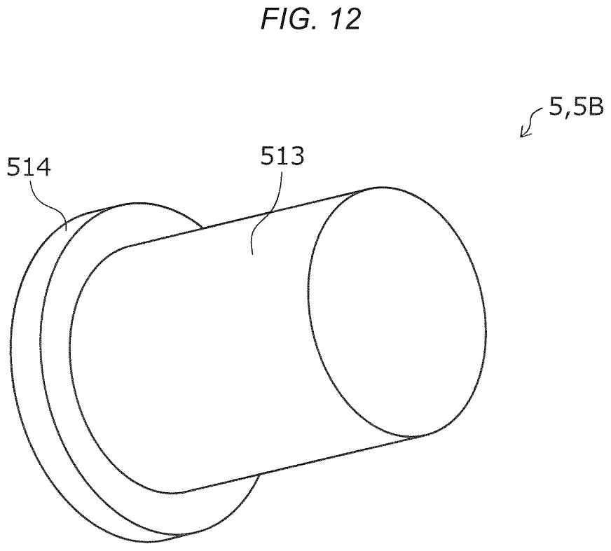

Then, the recording apparatus 1 according to Embodiment 2 will be described using FIGS. 10 to 12. In FIGS. 10 to 12, components common with those in Embodiment 1 are denoted by the same reference characters, and the detailed description thereof will be omitted. Here, the recording apparatus 1 according to the embodiment has the same configuration as the recording apparatus 1 according to Embodiment 1 except for a configuration of the closing member 5 (a closing member 5B). Accordingly, the recording apparatus 1 according to the embodiment has the same characteristics as those of the recording apparatus 1 according to Embodiment 1 except for portions described below.

As illustrated in FIG. 6 and the like, the closing member 5A of the recording apparatus 1 according to Embodiment 1 is configured such that the entire closing member 5 is inserted into the inside 31b of the hollow shaft 31. In contrast, as illustrated in FIGS. 10 to 12, the closing member 5B of the recording apparatus 1 according to the embodiment has a configuration in which a part of the closing member 5B protrudes to an outside of the hollow shaft 31 and is inserted into the inside 31b of the hollow shaft 31.

In other words, as illustrated in FIGS. 10 to 12, in the recording apparatus 1 according to the embodiment, the first closing member 51 of the closing member 5B includes an insertion portion 513 that is inserted into the inside 31b of the hollow shaft 31, and an abutment portion 514 that prevents the first closing member 51 from moving in a direction from the first opening 311 toward the second opening 312 by at least partially abutting against an edge of the first opening 311 when the insertion portion 513 is inserted into the hollow shaft 31. That is, since at least a part of the first closing member 51 does not enter the inside 31b of the hollow shaft 31, the entire first closing member 51 can be prevented from entering the inside 31b of the hollow shaft 31 and moving to an unexpected position. The closing member 5B according to the embodiment is formed of a material (a soft material) that is not an elastic porous member, but may be formed of a porous member.

### Embodiment 3

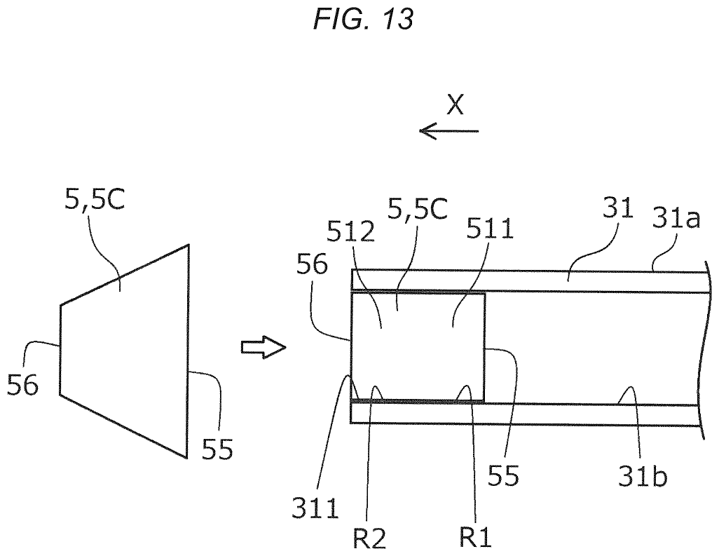

Then, the recording apparatus 1 according to Embodiment 3 will be described using FIG. 13. In FIG. 13, components common with those in Embodiment 1 are denoted by the same reference characters, and the detailed description thereof will be omitted. Here, the recording apparatus 1 according to the embodiment has the same configuration as the recording apparatuses 1 according to Embodiment 1 and Embodiment 2 except for a configuration of the closing member 5 (a closing member 5C). Accordingly, the recording apparatus 1 according to the embodiment has the same characteristics as those of the recording apparatuses 1 according to Embodiment 1 and Embodiment 2 except for portions described below.

The closing member 5C of the recording apparatus 1 according to the embodiment has a frustoconical shape before being attached to the hollow shaft 31. The closing member 5C is made of a porous member, and the porous member has a uniform bubble density before being attached to the hollow shaft 31. As illustrated in FIG. 13, when the closing member 5C in a frustoconical shape is attached to the hollow shaft 31, the closing member 5C is attached to the hollow shaft 31 by pushing a surface side having a large area into the inside 31b of the hollow shaft 31.

In other words, in a state before the first closing member 51 is inserted into the hollow shaft 31, the porous member in the first closing member 51 of the closing member 5C of the recording apparatus 1 according to the embodiment has a cross-sectional area increasing from a first direction side 56 toward a second direction side 55, and is inserted into the hollow shaft 31 from an opening with the second direction side 55 as a head. With such a configuration, it is possible to increase the bubble density on a through hole H side (a side opposite to the first opening 311 in the X-axis direction) when inserted into the hollow shaft 31. By reducing a suction force caused by the capillary phenomenon from the through hole H side to the first opening 311 side, the lubricant is less likely to move to the first opening 311 side, and the possibility that the lubricant leaks from the first opening 311 can be reduced. The second closing member 52 has the same configuration as the first closing member 51.

With such a configuration, the first closing member 51 of the closing member 5C is formed of a porous member, and in a state in which the first closing member 51 of the closing member 5C is inserted into the hollow shaft 31, the bubble density of the porous member decreases toward the first opening 311 and increases away from the first opening 311. The first closing member 51 of the closing member 5C includes the through-hole-side closing member 511 inserted into the first region R1 including at least a part of a region between the through hole H and the first opening 311, and the first-opening-side closing member 512 inserted into the second region R2, which is a region closer to the first opening 311 than the first region R1, and a bubble density of the first-opening-side closing member 512 is less than a bubble density of the through-hole-side closing member 511.

### Embodiment 4

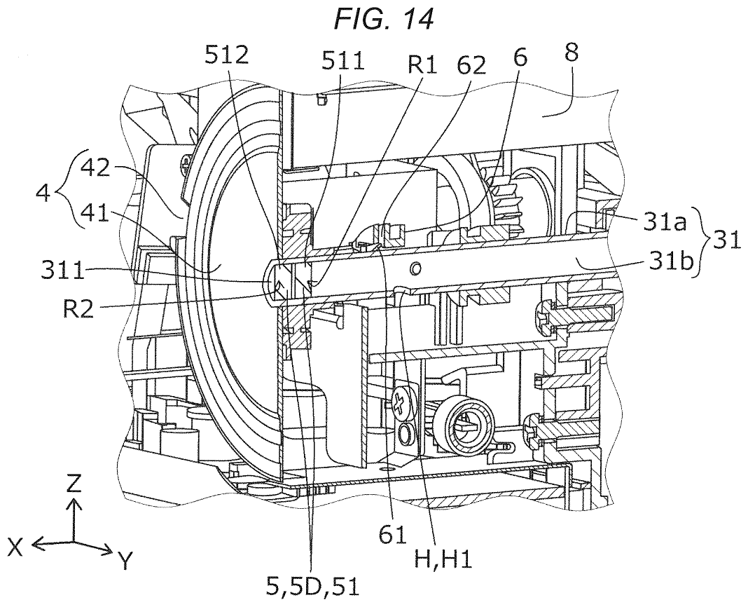

Then, the recording apparatus 1 according to Embodiment 4 will be described using FIG. 14. In FIG. 14, components common to Embodiment 1 are denoted by the same reference numerals, and the detailed description thereof will be omitted. Here, the recording apparatus 1 according to the embodiment has the same configuration as the recording apparatuses 1 according to Embodiment 1 to Embodiment 3 except for a configuration of the closing member 5 (a closing member 5D). Accordingly, the recording apparatus 1 according to the embodiment has the same characteristics as those of the recording apparatuses 1 according to Embodiment 1 to Embodiment 3 except for portions described below.

In the recording apparatuses 1 according to Embodiment 1 and Embodiment 3, the through-hole-side closing member 511 and the first-opening-side closing member 512 of the first closing member 51 are configured as one member. However, in the recording apparatus 1 according to the embodiment, as illustrated in FIG. 14, in the first closing member 51, the through-hole-side closing member 511 inserted into the first region R1 including at least a part of the region between the through hole H and the first opening 311 and the first-opening-side closing member 512 inserted into the second region R2, which is a region closer to the first opening 311 than the first region R1, are separately configured. A bubble density of the first-opening-side closing member 512 is less than a bubble density of the through-hole-side closing member 511.

Even with such a configuration, the suction force caused by the capillary phenomenon can be reduced from the through hole H side to the first opening 311 side. Therefore, the lubricant is less likely to move to the first opening 311 side, and the possibility that the lubricant leaks from the first opening 311 can be reduced. The second closing member 52 has the same configuration as the first closing member 51. In the embodiment, the first closing member 51 includes two members of the through-hole-side closing member 511 and the first-opening-side closing member 512, and the first closing member 51 may include three or more members.

The present disclosure is not limited to the embodiments and the modified examples described above, and various modifications can be made within the scope of the present disclosure set forth in the appended claims, and it is obvious that these modifications also fall within the scope of the present disclosure.

What is claimed is:

1. A recording apparatus comprising:
a recording unit configured to perform recording on a medium;
a transport unit including a cylindrical hollow shaft having a first opening at one end in a rotation axis direction and a second opening at the other end in the rotation axis direction, and configured to transport the medium by rotating in a state in which a circumferential surface of the hollow shaft is in contact with the medium;
a detection unit provided at least partially at a position that is closer to the first opening than is the second opening in the hollow shaft, and configured to detect a rotation amount of the hollow shaft;
a contact member in contact with the hollow shaft; and
a lubricant holding member configured to hold a lubricant and supply the lubricant to a contact portion between the hollow shaft and the contact member, wherein
the hollow shaft has a through hole formed at any position of the circumferential surface, and includes a first closing member that is a closing member press-fitted into an opening to close the opening, the first closing member being press-fitted into the first opening to close the first opening, and
the first closing member can be press-fitted into the first opening to prevent a lubricant entering an inside of the circumferential surface via the through hole from flowing out from the first opening.

2. The recording apparatus according to claim 1, wherein
the hollow shaft includes a second closing member that is the closing member and is press-fitted into the second opening to close the second opening.

3. The recording apparatus according to claim 1, wherein
the closing member has absorbency and is configured to absorb a lubricant.

4. The recording apparatus according to claim 1, wherein
the recording unit performs recording by ejecting a liquid onto the medium,
the recording apparatus includes a first waste liquid absorber configured to absorb a liquid discharged from the recording unit in a cleaning operation of the recording unit,
the closing member has absorbency and is configured to absorb a lubricant, and
a material of the closing member is the same as a material of the first waste liquid absorber.

5. The recording apparatus according to claim 1, wherein
the recording unit performs recording by ejecting a liquid onto the medium,
the recording apparatus includes a second waste liquid absorber configured to absorb a liquid which is ejected from the recording unit and spills over from the medium in a recording operation,
the closing member has absorbency and is configured to absorb a lubricant, and
a material of the closing member is the same as a material of the second waste liquid absorber.

6. The recording apparatus according to claim 1, wherein
the recording unit performs recording by ejecting a liquid onto the medium,
the recording apparatus includes a cap configured to cover a liquid ejection surface of the recording unit, and a third waste liquid absorber provided in the cap and configured to absorb a liquid ejected from the recording unit,
the closing member has absorbency and is configured to absorb a lubricant, and
a material of the closing member is the same as a material of the third waste liquid absorber.

7. The recording apparatus according to claim 1, wherein
the first closing member includes an insertion portion inserted into the hollow shaft, and an abutment portion configured to prevent the first closing member from moving in a direction from the first opening toward the second opening by at least partially abutting against an edge of the first opening when the insertion portion is inserted into the hollow shaft.

8. The recording apparatus according to claim 1, further comprising:
a frame made of metal, wherein
the hollow shaft and the contact member are made of metal, and
the contact member is in contact with the frame.

9. The recording apparatus according to claim 1, wherein
the first closing member is formed of a porous member, and
in a state in which the first closing member is inserted into the hollow shaft, a bubble density of the porous member decreases toward the first opening and increases away from the first opening.

10. The recording apparatus according to claim 9, wherein
in a state before the first closing member is inserted into the hollow shaft, the porous member has a cross-sectional area increasing from a first direction side toward a second direction side, and is inserted into the hollow shaft from the opening with the second direction side as a head.

11. The recording apparatus according to claim 9, wherein
the first closing member includes a through-hole-side closing member inserted into a first region including at least a part of a region between the through hole and the first opening, and a first-opening-side closing member inserted into a second region that is closer to the first opening than is the first region, and
a bubble density of the first-opening-side closing member is less than a bubble density of the through-hole-side closing member.
